(19) United States
(12) Patent Application Publication
(10) Pub. No.: US 2011/0293501 A1
(43) Pub. Date: Dec. 1, 2011

(54) LARGE SCALE GREEN MANUFACTURING OF AMMONIA USING PLASMA

(76) Inventor: James Charles Juranitch, Ft. Lauderdale, FL (US)

(21) Appl. No.: 12/998,695

(22) PCT Filed: Nov. 19, 2009
(86) PCT No.: PCT/US2009/006207

§ 371 Date: Aug. 15, 2011

Related U.S. Application Data
(60) Provisional application No. 61/199,837, filed on Nov. 19, 2008.

(51) Int. Cl. C01C 1/04

(52) U.S. Cl. 423/359; 423/352

(57) ABSTRACT

A method and system for converting waste using plasma into ammonia. The method uses minimal fossil fuel, and therefore produces a minimal carbon footprint when compared to conventional processes. The method includes the steps of supplying a biomass material to a plasma melter; supplying electrical energy to the plasma melter; supplying steam to the plasma melter; extracting a syngas from the plasma melter; extracting hydrogen from the syngas; and forming ammonia from the hydrogen produced in the step of extracting hydrogen.

### RELATIONSHIP TO OTHER APPLICATION

This application claims the benefit of the filing date of U.S. Provisional Patent Application Ser. No. 61/199,837, filed on Nov. 19, 2008, Confirmation No. 6775 (Foreign Filing License granted). The disclosure in the identified provisional patent application is incorporated herein by reference.

### BACKGROUND OF THE INVENTION

1. Field of the Invention

This invention relates generally to methods and systems for extracting hydrogen, and more particularly, to a system for manufacturing ammonia on a large scale.

2. Description of the Related Art

In the current energy environment there is continuing pressure to produce more products and energy in a cost effective and clean way. Fuel prices continue to climb, and emission standards continue to tighten. Most of the modern world has attempted to limit the amount of carbon dioxide that is emitted into the atmosphere. It is considered by many that this gas has some responsibility in the climatic changes commonly referred to as “global warming.”

The current method of producing ammonia typically begins with fossil fuels such as coal, oil, natural gas, propane, butane, naphtha, etc. that are processed to liberate hydrogen. This known approach disadvantageously strains limited resources. The known processes liberate significant amounts of carbon dioxide and other green house gasses that are believed by some to contribute to global warming. In addition to environmental effects, the known processes have resulted in political unrest, such as in China where the population battled over the rationing of fertilizer containing ammonia. The political unrest resulted from the fact that the fossil fuels needed to produce the ammonia were preferentially redirected to other fuel starved areas.

In 2006 the worldwide production of ammonia was approximately 146.5 million tons. It is believed that political problems will worsen in the future. For example, it was estimated that in 2003 83% of all ammonia produced was used to produce fertilizer. Moreover, it has been published that over 33% of the worlds food supply is generated through the use of fertilizer, and some have argued that the percentage is higher. It is therefore evident that with reasonably anticipated population growth and increasing competition for arid land, the reliance on fertilizer will only increase.

In 2004 China was the largest producer of fertilizer for the world at 28.4%, followed by India at 8.6%, Russia at 8.4%, and the United States at 8.2%. None of the operations in these countries use large scale renewable resources. Europe, up until the end of WWII, used a 60 MW hydroelectric power plant at Vermork, Norway to produce ammonia. The plant produced the required key ingredient, hydrogen, using an electrolysis process. Electrolysis is generally not economically feasible for producers who are not blessed with hydroelectric power. At that time, much of the ammonia was used to produce munitions for war, and the economics of such application of resources was not questioned. The foregoing notwithstanding, the Vermork site was a prominent example of ammonia production using a non-carbon-liberating base of production to date.

Plasma melters are now becoming a reliable technology that is used to destroy waste. At this time there are few operational plasma melter installations but the technology is gaining acceptance. It is a characteristic of plasma melters that they produce a low BTU syngas consisting of several different elements. If the plasma melters are operated in a pyrolysis mode of operation, they will generate large amounts of hydrogen and carbon monoxide. The syngas byproduct typically is used to run stationary power generators, and the resulting electric power is sold to the power grid.

It is, therefore, an object of this invention to provide a system for liberating hydrogen.

It is another object of this invention to provide a system for liberating hydrogen on a large scale and that does not require large electrical generation resources.

It is also an object of this invention to provide a system for liberating hydrogen that does not require consumption of natural resources.

It is a further object of this invention to provide a method and system of producing ammonia inexpensively.

It is additionally an object of this invention to provide an inexpensive method of using hydrogen to produce ammonia.

It is yet a further object of this invention to provide an inexpensive method of using a plasma melter to generate large amounts of hydrogen.

It is also another object of this invention to provide a method of generating hydrogen wherein waste carbon dioxide is obtained from a renewable energy source and therefore does not constitute an addition to the green house gas carbon base.

### SUMMARY OF THE INVENTION

The foregoing and other objects are achieved by this invention which provides a method of manufacturing ammonia on a large scale. In accordance with the invention, the method includes the steps of:
supplying a fuel material to a plasma melter;
supplying electrical energy to the plasma melter;
supplying steam to the plasma melter;
extracting a syngas from the plasma melter;
extracting hydrogen from the syngas; and
forming ammonia from the hydrogen produced in the step of extracting hydrogen.

In an advantageous embodiment of the invention, the fuel material that is supplied to the plasma melter is a municipal waste. In other embodiments, the waste material is a municipal solid waste, and in still other embodiments the waste material is a biomass. In some embodiments where the waste material is a biomass, the biomass is specifically grown to be supplied to the plasma melter.

In other advantageous embodiments of the invention other waste materials or fuels are employed to achieve the production of ammonia. Such other waste materials or fuels include, for example, fossil fuels. In other embodiments, the fossil fuels are combined to form a fossil fuel cocktail that includes, for example, a biomass material, municipal solid waste, and coal. In still other embodiments, the fossil fuels may be of a low quality, such as brown coal, tar sand, and shale oil.

In one embodiment of the invention, the step of extracting hydrogen from the syngas includes, but is not limited to, the steps of:
subjecting the syngas to a water gas shift process to form a mixture of hydrogen and carbon dioxide; and
extracting hydrogen from the mixture of hydrogen and carbon dioxide.

In a further embodiment, the step of extracting hydrogen from the mixture of hydrogen and carbon dioxide includes, but is not limited to, the step of subjecting the mixture of hydrogen and carbon dioxide to a pressure swing adsorption process. In some embodiments, the step of extracting hydrogen from the mixture of hydrogen and carbon dioxide includes, but is not limited to, the step of subjecting the mixture of hydrogen and carbon dioxide mixture to a molecular sieve. In a further embodiment, the step of extracting hydrogen from the mixture of hydrogen and carbon dioxide includes, but is not limited to, the step of subjecting the mixture of hydrogen and carbon dioxide mixture to an aqueous ethanolamine solution. In yet another embodiment, prior to performing the step of subjecting the syngas to a water gas shift process to form a mixture of hydrogen and carbon dioxide there is provided the step of pre-treating the output of the plasma melter to perform a cleaning of the syngas.

In accordance with an advantageous embodiment of the invention, the step of forming ammonia from the hydrogen produced in the step of extracting hydrogen includes, but is not limited to, the step of subjecting the hydrogen to a Haber-Bosch process. In some embodiments, prior to performing the step of forming ammonia from the hydrogen produced in the step of extracting hydrogen, there is provided the further step of supplying nitrogen to the Haber-Bosch process. The step of supplying nitrogen to the

Haber-Bosch process includes, in some embodiments, the step of extracting nitrogen from air. This step of extracting nitrogen from air includes, but is not limited to, the further step of subjecting the air to a pressure swing adsorption process. In other embodiments of the invention, the nitrogen is extracted from the plasma melter. In a highly advantageous embodiment of the invention, the step of extracting nitrogen from the plasma melter includes the performing of a continuous process of nitrogen production from the plasma melter.

In an advantageous embodiment of the invention, there is provided the step of extracting a slag from the plasma melter.

### BRIEF DESCRIPTION OF THE DRAWING

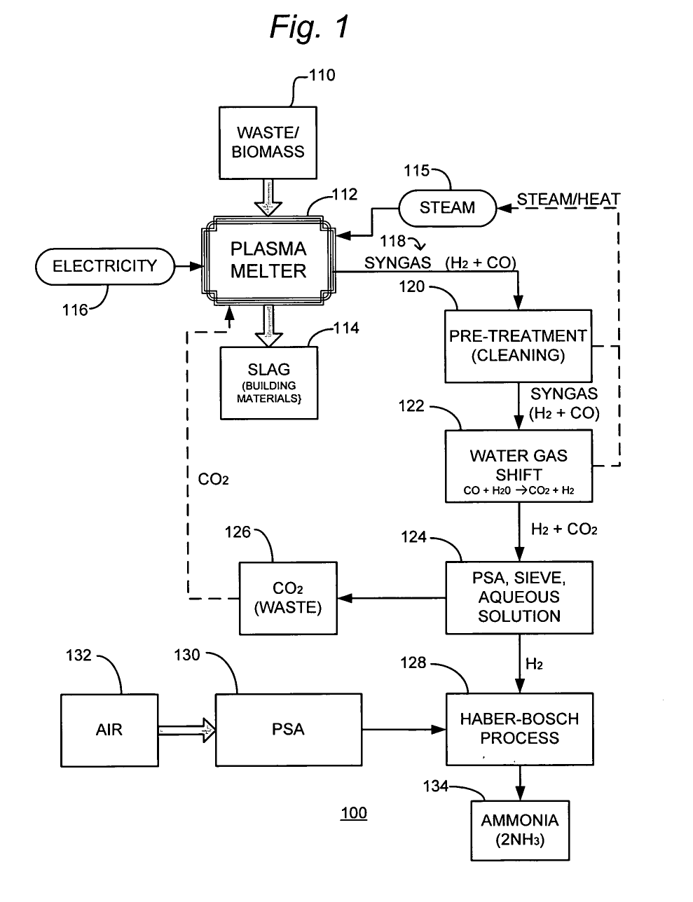

Comprehension of the invention is facilitated by reading the following detailed description, in conjunction with the annexed drawing, in which FIG. 1 is a simplified function block and schematic representation of a specific illustrative embodiment of the invention.

### DETAILED DESCRIPTION

FIG. 1 is a simplified function block and schematic representation of a specific illustrative embodiment of the invention. As shown in this figure, an ammonia producing system 100 receives municipal waste, or specifically grown biomass 110 that is deposited into a plasma melter 112. In the practice of some embodiments of the invention, the process is operated in a pyrolysis mode (i.e., lacking oxygen). Steam 115 is delivered to plasma melter 112 to facilitate production of hydrogen and plasma. Also, electrical power 116 is delivered to plasma melter 112. A hydrogen rich syngas 118 is produced at an output (not specifically designated) of plasma melter 112, as is a slag 114 that is subsequently removed.

In some applications of the invention, slag 114 is sold as building materials, and may take the form of mineral wool, reclaimed metals, and silicates, such as building blocks. In some embodiments of the invention, the BTU content, plasma production, and slag production can also be “sweetened” by the addition of small amounts of coke or other additives (not shown). Such additives, which may in some embodiments constitute waste materials or fuels include, for example, fossil fuels. In other embodiments, the fossil fuels are combined to form a fossil fuel cocktail that includes, for example, a biomass material, municipal solid waste, and coal. In still other embodiments, the fossil fuels or additives may be of a low quality, such as brown coal, tar sand, and shale oil.

The syngas is cooled, cleaned, and separated in a pretreatment step 120. The carbon monoxide is processed out of the cleaned syngas at the output of a Water Gas Shift reaction 122. The waste carbon dioxide 126 that is later stripped out is not considered an addition to the green house gas carbon base. This is due to the fact it is obtained in its entirety from a reclaimed and renewable source energy. In this embodiment of the invention, the energy source is predominantly municipal waste 110.

In some embodiments, the carbon dioxide is recycled into the plasma melter 112 and reprocessed into carbon monoxide and hydrogen. A Pressure Swing Adsorption (PSA) process, molecular sieve, aqueous ethanolamine solutions, or other processes are used in process step 124 to separate out carbon dioxide 126. Hydrogen from process step 124 is delivered to a conventional Haber Bosch process 128, which is a well-known large scale high pressure process for producing ammonia, or other similar process, to produce ammonia 134. The required nitrogen is extracted from air 132 through a PSA 130 or any other conventional method. As previously noted, the nitrogen is, in some embodiments of the invention, extracted from the plasma melter. Pretreatment step 120 and Water Gas Shift reaction 122 generate heat that in some embodiments of the invention is used to supply steam to the plasma melter, or to a turbine generator (not shown), or any other process (not shown) that utilizes heat.

Although the invention has been described in terms of specific embodiments and applications, persons skilled in the art may, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof.

What is claimed is:

1. A method of manufacturing ammonia on a large scale, the method comprising the steps of:
supplying a fuel material to a plasma melter;
supplying electrical energy to the plasma melter;
supplying steam to the plasma melter;
extracting a syngas from the plasma melter;
extracting hydrogen from the syngas; and
forming ammonia from the hydrogen produced in said step of extracting hydrogen.

2. The method of claim 1, wherein said step of supplying a fuel material to the plasma melter comprises the step of supplying municipal waste to the plasma melter.

3. The method of claim 1, wherein said step of supplying a fuel material to the plasma melter comprises the step of supplying a fossil fuel to the plasma melter.

4. The method of claim 3, wherein said step of supplying a fossil fuel to the plasma melter comprises the step of supplying a fuel mixture formed of a selectable combination of a biomass material, municipal solid waste, coal, brown coal, tar sand, and shale oil.

5. The method of claim 1, wherein said step of supplying a fuel material to the plasma melter comprises the step of supplying a biomass material to the plasma melter.

6. The method of claim 5, wherein the biomass material is specifically grown for being supplied to the plasma melter.

7. The method of claim 1, wherein said step of extracting hydrogen from the syngas comprises the steps of:
subjecting the syngas to a water gas shift process to form a mixture hydrogen and carbon dioxide; and
extracting hydrogen from the mixture hydrogen and carbon dioxide.

8. The method of claim 7, wherein said step of extracting hydrogen from the mixture of hydrogen and carbon dioxide comprises the step of subjecting the mixture of hydrogen and carbon dioxide mixture to a pressure swing adsorption process.

9. The method of claim 7, wherein said step of extracting hydrogen from the mixture of hydrogen and carbon dioxide comprises the step of subjecting the mixture of hydrogen and carbon dioxide mixture to a molecular sieve.

10. The method of claim 7, wherein said step of extracting hydrogen from the mixture of hydrogen and carbon dioxide comprises the step of subjecting the mixture of hydrogen and carbon dioxide mixture to an aqueous ethanolamine solution.

11. The method of claim 7, wherein prior to performing said step of subjecting the syngas to a water gas shift process to form a mixture of hydrogen and carbon dioxide there is provided the step of pre-treating the output of the plasma melter to perform a cleaning of the syngas.

12. The method of claim 7, wherein prior to performing said step of subjecting the syngas to a water gas shift process to form a mixture of hydrogen and carbon dioxide there is provided the step of pre-treating the output of the plasma melter to perform a segregation of the syngas.

13. The method of claim 1, wherein said step of forming ammonia from the hydrogen produced in said step of extracting hydrogen comprises the step of subjecting the hydrogen to a Haber-Bosch process.

14. The method of claim 13, wherein prior to performing said step of forming ammonia from the hydrogen produced in said step of extracting hydrogen there is provided the further step of supplying nitrogen to the Haber-Bosch process.

15. The method of claim 14, wherein said step of supplying nitrogen to the Haber-Bosch process comprises the step of extracting nitrogen from air.

16. The method of claim 15, wherein said step of extracting nitrogen from air comprises the step of subjecting the air to a pressure swing adsorption process.

17. The method of claim 14, wherein said step of supplying nitrogen to the Haber-Bosch process comprises the step of extracting nitrogen from the plasma melter.

18. The method of claim 17, wherein said step of extracting nitrogen from the plasma melter comprises performing a continuous process of nitrogen production from the plasma melter.

19. The method of claim 1, wherein there is further provided the step of extracting a slag from the plasma melter.

20. The method of claim 1, wherein the plasma melter is operated in a pyrolysis mode.
